(19) United States
(12) Patent Application Publication
(10) Pub. No.: US 2021/0179860 A1
(43) Pub. Date: Jun. 17, 2021

(54) CLEANING COMPOSITION PROVIDING A MOISTURE AND ULTRAVIOLET LIGHT BARRIER

(71) Applicants: Connor J. Walden, Gover, MO (US); David Walden, Wildwood, MO (US)

(72) Inventors: Connor J. Walden, Gover, MO (US); David Walden, Wildwood, MO (US)

(21) Appl. No.: 17/187,053

(22) Filed: Feb. 26, 2021

Related U.S. Application Data
(63) Continuation-in-part of application No. 17/121,133, filed on Dec. 14, 2020.
Application No. 17/121,133 is a continuation of application No. 16/049,071, filed on Jul. 30, 2018, now Pat. No. 10,865,315.
Application No. 16/049,071 is a continuation of application No. 15/456,997, filed on Mar. 13, 2017, now Pat. No. 10,035,917.
Application No. 15/456,997 is a continuation of application No. 14/672,414, filed on Mar. 30, 2015, now Pat. No. 9,624,382.
Application No. 14/672,414 is a continuation of application No. 13/839,549, filed on Mar. 15, 2013, now Pat. No. 8,999,234.
(60) Provisional application No. 61/649,014, filed on May 18, 2012.
(60) Provisional application No. 61/613,731, filed on Mar. 21, 2012.

(51) Int. Cl. C09D 5/08; C09D 191/00; C09D 191/06; C23F 11/00

(52) U.S. Cl. CPC C09D 5/08; C09D 191/00; C08L 2205/02; C23F 11/00; C09D 191/06

(57) ABSTRACT

A composition which serves to clean and create of a protective barrier on a wide variety of materials to prevent the deterioration and degradation caused by exposure to moisture and sun over time.

### CROSS REFERENCE TO RELATED APPLICATION

This Application is a Continuation-In-Part (CIP) of U.S. Utility patent application Ser. No. 17/121,133, filed Dec. 14, 2020, which is a Continuation of U.S. Utility patent application Ser. No. 16/049,071, filed Jul. 30, 2018, which is a Continuation of U.S. Utility patent application Ser. No. 15/456,997, filed Mar. 13, 2017, which is a Continuation of U.S. Utility patent application Ser. No. 14/672,414, filed Mar. 30, 2015, which is a Continuation of U.S. Utility patent application Ser. No. 13/839,549, filed Mar. 15, 2013, which claims the benefit of U.S. Provisional Patent Application Ser. No. 61/649,014, filed May 18, 2012 and U.S. Provisional Patent Application Ser. No. 61/613,731, filed Mar. 21, 2012. The entire disclosures of all the above applications are herein incorporated by reference.

### BACKGROUND OF THE INVENTION

### 1. Field of the Invention

This disclosure is related to the field of compositions for the cleaning and creation of a protective barrier against moisture and ultraviolet light on various materials and particularly iron containing compounds.

### 2. Description of Related Art

Water and sun are two forces capable of wreaking havoc on a vast number of material surfaces, causing them to degrade and deteriorate with the passage of time. For example, water intrusion can enable the attack of a material or system by destructive processes such as the rotting of wood, rusting of metals and the de-lamination of plywood, amongst many other degrading processes. In addition, sun damage can result in fading and breakdown in the integrity of materials such as plastics, vinyl and rubber.

The impact of this damage over time on the economy as a whole cannot be underestimated. For example, the impact of just one of these destructive processes, rust, is immense. Rust is the general colloquial term for a series of oxides that form on iron and its alloys (such as steel) as a result of the reaction of iron and oxygen in the presence of water or moisture. Basically, when iron is in contact with water and oxygen, it rusts. Iron metal is relatively unaffected by pure water or by dry oxygen alone; the combination needs to be present for rust to form. This is because a tightly adhering oxide coating, known as a passivation layer, protects the bulk of the iron from oxidation. It is the passivating layer itself that converts to rust from exposure to the combined action of oxygen and water.

Chemically, the rusting of iron is an electrochemical process that begins with the transfer of electrons from iron to oxygen: O₂+4 e⁻+H₂O→4 OH⁻. From this equation, it is illustrated that the occurrence of corrosion is dictated by the availability of water and oxygen. Further, the rate of corrosion reactions can be accelerated by electrolytes (this is illustrated by the accelerating effects of road salt on rust formation in automobiles).

Because rust is basically a reaction on the passivation layer of the iron substance, the rust layer does not generally adhere or stay permanently attached to the bulk metal substance. Rather, it forms, flakes off the surface and, as it flakes, exposes fresh iron. Generally, given sufficient time, this cyclic corrosion process will continue until an iron mass will eventually convert entirely to rust and disintegrate.

It is commonly known that the corrosion of metallic structures has a significant impact on the United Stales economy, including infrastructure, transportation, utilities, production, manufacturing and governmental sectors. One of the pioneering benchmark studies on the cost of corrosion performed in 1975 calculated the costs to be about $70 billion per year, or about 4.2 percent of the nation's gross domestic product (GDP). A more recent study commissioned by the Federal Highway Administration (FHWA) in 2001 showed that the cost of corrosion to the overall American economy had not significantly waned in the intervening decades. The study determined the direct costs of corrosion to the United States economy to be $279 billion per year or about 3.2 percent of the United States GDP. When indirect costs (otherwise known as society costs) to the user were taken into account, the overall corrosion costs rose to about 6 percent of the GDP. Economic sectors that are commonly affected by corrosion and rust formation include, but are not limited to, infrastructure (e.g., highway bridges, gas and liquid transmission pipelines, waterways and ports, hazardous materials storage, airports and railroads), utilities (e.g., gas distribution, drinking water and sewer systems, electrical utilities and telecommunications), transportation (e.g., motor vehicles, ships, aircrafts, railroad cuts, and hazardous materials transport), production and manufacturing (e.g., oil and gas exploration and production, mining, petroleum refining, chemical, petrochemical and pharmaceutical, pulp and paper, agricultural, food processing, electronics and home appliances) and government (e.g., defense and nuclear waste storage).

Thus, the economic impact of rust on infrastructure systems and the economy as a whole is large. Traditionally utilized rust prevention techniques generally include, but are not limited to, protective coatings, corrosion-resistant alloys, corrosion inhibitors, polymers, anodes, cathodic protection and corrosion control and monitoring equipment. However, despite the availability of these corrosion control methodologies, the negative impact of corrosion and rust on the United States economy keeps rising. Obviously, the presently employed strategies are not enough to win the ever-waging battle against rust. New, more effective methods to combat rust and its growing negative impact on the United Suites economy are therefore needed.

Further, even if rust prevention techniques are available, they are not always used correctly. In addition to having a rust inhibitor applied, many metal objects require regular cleaning and have moving parts and chemical materials on them which can inhibit correct use of rust inhibiting coatings. Rust inhibitors will typically work best when applied to a clean surface free of dirt particles or chemicals and need to be left alone and not exposed to harsh chemicals or mechanical wear to avoid being worn off. It should be apparent that a process of protecting an iron containing product and then never touching it again to maintain the protection is often impossible. Therefore, most rust inhibiting compounds need to be periodically reapplied to maintain their protective nature.

One of the most commonly used rust inhibiting compounds are oils or greases. Simple oils (such as fish oils, animal oils, and petroleum-based products) have been used for a long time as a coating of iron surfaces to inhibit rust. Oils are effective because they repel water and without water oxidation can typically not occur. Liquid oils are therefore commonly used to coat all sorts of iron objects to help them avoid corrosion, and often to help moving parts function with reduced friction. Liquid oils are popular because they are easily applied, readily available, and can also generally readily How around odd sized parts and into grooves and openings. Thus, they are relatively easy to apply for protection.

Use of simple oils can, however, present their own issues. For one, the same thing that typically makes simple oils easy to apply can also make them relatively simple to remove. Thus, many objects that use oil for protection use it only when the object is not is use or else have to be very regularly applied after use. A second problem is that oils can also attract and hold dust and grime and can go rancid if they are sourced from animals. While dirt containment can be useful in certain circumstances to avoid mechanical damage to moving parts, the very same thing that makes oils good protectants can also make it hard to clean surfaces with oils on them making them sticky and hard to use. Thus, iron objects often must be thoroughly cleaned between uses to remove old oil and replace it. While this is effective, it is time consuming.

Dirt and grime accumulation in protective oil can be a particular problem for small precision machines where dirt particles are relatively larger compared to operational components. These may have little tolerance to work through the dirt which can foul their operations. Further, the presence of dirt and grime on a small machine can be hard to remove and can be problematic as also inhibiting the adhesion of rust inhibitor or cause rust inhibitors to be placed on a surface which is not the metal itself. As simple examples, dirt on the surface may quickly flake off taking the oil material with it or chemicals on a surface can react with the oil forcing it to work incompletely.

Typically, cleaning of the surface prior to oil application is a separate step to applying the oil. While this can work in many cases, it is not always ideal. In the first instance, as a separate step, it makes the application of oil a much longer process, which can result in people being less willing to do it. More importantly, however, because the cleaning step is separate from the oil application, the cleaning step may miss dirt or residue, the application of oil may miss areas for protection, and the need to carry out a two-step process can simply result in reduced performance of a rust inhibitor.

The risk of reduced performance is particularly true on devices that require regular cleaning and potential reapplication of rust inhibitor to be effective and which have multiple parts to clean and protect or where access to parts to be cleaned and treated can be difficult. One such item are firearms. Firearms are complicated mechanical devices many parts of which are difficult to completely access even after complete disassembly. This type of problem carries over to many other smaller precision machines as well.

A final problem with a separate cleaning step is making sure that selected cleaning compounds are compatible with the resultant rust inhibitor or the cleaning compound can leave behind undesirable residues which inhibit correct application of the rust inhibitor. One example is the cleaning and protecting of high carbon steel objects such as blades. Knives (and swords) often benefit from having a thin protectant coating on them. However, these can also readily have problems have having too much protectant and becoming sticky or dirty. Removal of old oil typically uses alcohols, but one must make sure that the alcohol has evaporated before applying replacement oil.

Similar to rust, more viable protection methodologies and solutions are also needed for other degradation and deterioration processes on a wide variety of materials (e.g., metals, wood, vinyl, plastic) that occur from exposure to moisture or sun over time. A new and effective protective composition that would act as a barrier to water and sun for these materials, protecting them for significant a significant period of time from these degrading and deteriorating processes, is therefore needed. Further, if this material can also act to clean the underlying material at the same time, the process of protection can be accelerated and simplified.

### SUMMARY OF THE INVENTION

Because of these and other problems in the art described herein, among other things, is a composition for cleaning and creating a protective barrier on a wide variety of materials to prevent the deterioration and degradation caused by exposure to moisture and sun over time.

In an embodiment, this comprises a rust inhibition and cleaning composition consisting essentially of a mixture of: a plant wax; an animal oil; and a cleaning agent. In one embodiment of the rust inhibition prevention composition, the plant wax comprises a carnauba wax and the animal oil comprises a mink oil. In yet another embodiment, this rust inhibition composition will further comprise a tallow. In still another embodiment, this rust inhibition prevention composition will further comprise an emulsifier. In one embodiment this emulsifier will be chosen from the group consisting of: glycerol esters of fatty acids, glycerol monooleate, Stoddard solvents, 1,2,4-trimethylbenzene, mineral spirits, and naptha. In still another embodiment, the prevention composition will further comprise a dye. In another embodiment, the prevention composition will further comprising a mineral oil. In another embodiment, the prevention composition will further comprising a fragrance. In another embodiment, the cleaning agent comprises a monoterpene such as, but not limited to, D-limonene.

There is disclosed herein, among other things, a rust inhibition and cleaning composition comprising: 10-20% of a carnauba wax; 1-8% of a 1,2,4 trimethylbenzene; 10-25% of a glycerol ester of C14, C18 fatty acids; 1-5% of a mink oil; 10-20% of a glycerol monooleate; 1-8% of a tallow; 25-35% of a Stoddard solvent; 4-12% of a mineral spirits, a naptha, or a combination; 10-20% of a mineral oil; and 1-5% of a cleaning agent including: a monoterpene, a monoterpenoid, or a combination thereof.

In an embodiment, the composition additionally comprises a fragrance.

In an embodiment of the composition, the fragrance comprises 0.1-1% of said composition.

In an embodiment of the composition, the fragrance includes citrus fragrance.

In an embodiment of the composition, the fragrance includes orange fragrance.

In an embodiment of the composition, the cleaning agent includes a monocyclic monoterpene.

In an embodiment of the composition, the cleaning agent includes a monocyclic monoterpenoid.

In an embodiment of the composition, the cleaning agent includes D-limonene. In an embodiment of the composition, the composition comprises: about 11% carnauba wax; about 2% 1,2,4 trimethylbenzene; about 14% glycerol ester of C14, C18 fatty acids; about 2% mink oil; about 14% glycerol monooleate; about 3% tallow; about 30% Stoddard solvent; about 7% mineral spirits; about 16% a mineral oil; and about 2% D-limonene.

In an embodiment of the composition, the composition comprises: about 11.01% carnauba wax; about 2.44% 1,2,4 trimethylbenzene; about 13.88% glycerol ester of C14, C18 tatty acids; about 1.88% mink oil; about 13.70% glycerol monooleate; about 2.84% tallow; about 29.22% Stoddard solvent; about 6.60% mineral spirits; about 15.93% a mineral oil; and about 2.00% D-limonene.

There is also described herein, in an embodiment, a method for applying a cleaning and rust inhibition composition to a surface of an inorganic object to be treated, the method comprising: providing a rust inhibition composition; heating the surface of the inorganic object to be treated to a temperature warm enough to melt or liquefy the rust inhibition composition on contact; applying the rust inhibition composition to the heated surface of the inorganic object to be treated, keeping the surface warm during the applying; and cooling the surface of the inorganic object to be treated back to room temperature after the step of applying; wherein the rust inhibition prevention composition comprises of a mixture of: 10-20% of a carnauba wax; 1-8% of a 1,2,4 trimethylbenzene; 10-25% of a glycerol ester of C14, C18 fatty acids; 1-5% of a mink oil; 10-20% of a glycerol monooleate; 1-8% of a tallow; 25-35% of a Stoddard solvent; 4-12% of a mineral spirits, a naptha, or a combination; 10-20% of a mineral oil; and 1-5% of a cleaning agent including: a monoterpene, a monoterpenoid, or a combination thereof.

In an embodiment, the method further comprises a fragrance.

In an embodiment of the method, the fragrance comprises 0.1-1% of said composition.

In an embodiment of the method, the fragrance includes citrus fragrance.

In an embodiment of the method, the fragrance includes orange fragrance.

In an embodiment of the method, the cleaning agent includes a monocyclic monoterpene.

In an embodiment of the method, the cleaning agent includes a monocyclic monoterpenoid.

In an embodiment of the method, the cleaning agent includes D-limonene.

In all embodiment of the method, the composition comprises; about 11% carnauba wax; about 2% 1,2,4 trimethylbenzene; about 14% glycerol ester of C14, C18 fatty acids; about 2% mink oil; about 14% glycerol monooleate; about 3% tallow; about 30% Stoddard solvent; about 7% mineral spirits; about 16% a mineral oil; and about 2% D-limonene.

In an embodiment of the method, the composition comprises: about 11.01% carnauba wax; about 2.44% 1,2,4 trimethylbenzene; about 13.88% glycerol ester of C14-C18 fatty acids; about 1.88% mink oil; about 13.70% glycerol monooleate; about 2.84% tallow; about 29.22% Stoddard solvent; about 6.60% mineral spirits; about 15.93% a mineral oil; and about 2.00% D-limonene.

### BRIEF DESCRIPTION OF THE DRAWINGS

FIG. 1 provides a chart of the raw materials of an embodiment of the moisture and ultraviolet light barrier composition.

FIG. 2 provides a chart of the raw materials of an alternative embodiment of the moisture and ultraviolet light barrier composition.

### DESCRIPTION OF THE PREFERRED EMBODIMENTS

This disclosure is intended to teach by way of example and not by way of limitation. The present disclosure focuses on a formulation for a composition which functions as a protective barrier against moisture, ultraviolet rays, stains, deposits, rust and fingerprints and other known deteriorating or degrading processes or substances known to those of ordinary skill in the art for a wide variety of materials. In one embodiment, this composition, in a simplified form, is comprised of a combination of waxes and water repellants. Also discussed herein are methods for the production of such compositions, along with various alternative methods of using such compounds in the prevention of water and sun deterioration or other known degrading processes on a wide variety of materials and products.

As noted previously, in its most general format, the composition disclosed herein is a rust inhibitor comprised of a combination of waxes and water repellants formed into a mixture. Any type of organic compound with a long alkyl chain that is malleable near ambient temperatures and is commonly known to those of skill in the art as a “wax” is contemplated as a wax component of the disclosed composition. Contemplated waxes include, but are not limited to: plant and animal waxes such as shellac wax, castor wax, carnauba wax and soy wax, petroleum waxes such as paraffin wax, mineral waxes such as ceresin wax, and synthetic waxes such as polyethylene wax. In certain embodiments, the contemplated wax in the composition is a shoe polish wax blend. Generally, any waxy colloidal emulsion shoe polish comprised of some or all of naptha, lanolin, turpentine, wax, gum Arabic, ethylene glycol and a colorant is contemplated. In preferred embodiments, the contemplated wax shoe polish will be comprised of carnauba wax. Commercial examples of contemplated shoe polish blends include, but are not limited to, Club Classic® paste polish, a carnauba wax blend. Further, organic water repellents are also contemplated as components in the disclosed composition. Generally, any organic water repellant known to those of ordinary skill in the art is contemplated as an organic water repellant component of the disclosed composition. Contemplated organic water repellents include animal oils, such as mink oil, and common alternatives thereto known to those of ordinary skill in the art (e.g., macadamia nut oil and sea buckthorn oil). However, it should be noted that, in certain embodiments, commercial water repellents could also be utilized.

In an alternative embodiment, the composition disclosed herein is a combination cleaning product and rust inhibitor. In these compositions, the rust inhibitor is typically similar in composition to the rust inhibitor product alone. To this composition there is then added a cleaning product which is compatible with the rest inhibitor. This combined product serves to clean the target metal (or other material) while the rust inhibiting composition is applied. Thus, cleaning and rust inhibition can be completed in a single step. The cleaning material is preferably a monoterpene or monoterpenoid. It will typically be a monocyclic monoterpene or monoterpenoid such as, but not limited to, limonene or perillyl alcohol.

While the invention is not intended to be limited to any effect of the modality of the deterioration and degradation prevention composition, it is hypothesized that one explanation for the effectiveness of this composition in preventing the deterioration and degradation caused over time by water and sun in addition to its ability to protect surfaces from stains and oily deposits is that the water repellant qualities of the wax and water repellent blend impede the water or moisture necessary for deterioration and degradation to occur from coming into contact with the surface area of a treated material. Further, the barrier formed by application of the composition on the material can also act as a barrier to ultraviolet rays, preventing these rays from coming into direct contact with the material, which direct contact results in a breakdown of the material over time.

In one embodiment of the disclosed prevention composition, the composition comprises: carnauba wax and mink oil. In another embodiment of the disclosed prevention composition, the composition consists of: carnauba wax and mink oil. In yet another embodiment of the disclosed composition, the composition consists essentially of: a plant wax and animal oil. In still another embodiment of the disclosed composition, the composition consists essentially of: a palm wax and an animal oil. In another embodiment of the disclosed composition, the composition consists essentially of: a carnauba wax and mink oil. In yet another embodiment of the disclosed composition, the composition consists essentially of: carnauba wax blend and mink oil. In more complex embodiments of the disclosed composition, the composition is further comprised of tallow such as, but not limited to, bleached tallow. This further component adds, amongst other properties, lubrication properties to the resultant composition.

In another embodiment, the composition is further comprised of certain emulsifiers and solvents known to those of ordinary skill in the art. Contemplated emulsifiers and solvents include, but are not limited to, glycerol esters of fatty acids, glycerol monooleate, Stoddard solvents, 1,2,4-trimethylbenzene, mineral spirits, and naptha. However, it should be noted that this list is not exclusive, as any emulsifier or solvent known to those of ordinary skill in the art is contemplated as a possible component of the disclosed composition. Further, in another embodiment, the disclosed composition is further comprised of a dye known to those of ordinary skill in the art that is compatible with silicon and wax type materials such as, but not limited to, carbon black. Notably, the color of the dye is not determinative; the color of the dye can vary depending upon how and upon what material the composition will be utilized. In one embodiment where the dye is black, the resultant composition will be black. In yet another embodiment, the composition will be further comprised of a mineral oil known to those of ordinary skill in the art and a contemplated fragrance. Contemplated fragrances include, but are not limited to, fruit, plant, flower and freshener scents known to those of ordinary skill in the art.

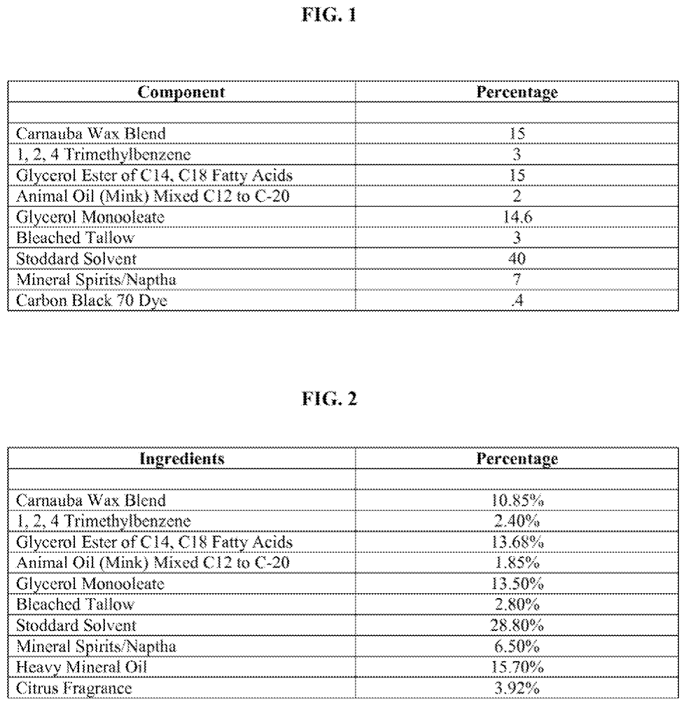

Generally, contemplated ranges for certain components of the composition in various different embodiments of rust inhibitor comprise, consist of, or consist essential of: about 10-20% carnauba wax blend; about 1-8% 1,2,4 trimethylbenzene; about 10-20% glycerol ester of C14, C18 fatty acids; about 1-5% of mink oil; about 10-20% glycerol monooleate; about 1-8% tallow; about 25-45% Stoddard solvent; about 4-12% mineral spirits/naptha; and about 0.2-1.5% carbon black dye. In a preferred embodiment of the composition, the specific percentages of the components are as follows: about 15% carnauba wax; about 3% 1,2,4 trimethylbenzene; about 15% glycerol ester of C14, C18 fatty acids; about 2% of mink oil; about 14.6% glycerol monooleate; about 3% tallow; about 40% Stoddard solvent; about 7% mineral spirits/naptha; and about 0.4% carbon black dye. FIG. 1 provides a chart of the raw materials of an embodiment of this specific preferred embodiment of the disclosed prevention composition. Notably, however, in no way is this listing of ranges and specific percentages intended to be exhaustive, as other ranges could be contemplated in additional embodiments of the composition.

In an alternative embodiment of the prevention and inhibition composition, generally for use in the home-goods industry amongst other applications, the specific percentages of the components are as follows: about 10.85% carnauba wax blend; about 2.40% 1,2,4 trimethylbenzene; about 13.68% glycerol ester of C14, C18 fatty acids; about 1.85% mink oil; about 13.5% glycerol monooleate; about 2.8% tallow; about 28.8% Stoddard solvent; about 6.5% mineral spirits/naptha; about 15.7% mineral oil; and about 3.92% citrus fragrance.

In embodiments of compositions for both cleaning and rust inhibition, the cleaning agent will be added to any of the above rust inhibiting compositions in an amount of about 1% to about 5% of the total resultant composition being cleaning agent and about 95% to about 99% being a rust inhibiting composition of the types contemplated above. In other embodiments, the cleaning agent comprises about 1.5% to about 3% of the total resultant composition being cleaning agent and about 97% to about 98.5% being a rust inhibiting composition of the types contemplated above. In still further embodiments, the cleaning agent comprises about 2% of the total resultant composition being cleaning agent and about 98% being a rust inhibiting composition of the types contemplated above. The cleaning agent will preferably be a monocyclic monoterpene such as, but not limited to, D-limonene. It should be apparent that the inclusion of the cleaning agent may alter the relative percentage of components of the rust inhibition composition in the resulting cleaning and inhibiting compound in an expected fashion.

In an alternative embodiment for a cleaning and inhibiting composition, which is particularly useful for small machines, such as, but not limited to, firearms amongst other applications, the rust inhibiting composition is altered so as to include an increased amount of mineral oil, which can make it more flowable, and the dye is removed to eliminate color. In an embodiment, the resulting composition comprises about 10-20% of a carnauba wax; about 1-8% of a 1,2,4 trimethylbenzene; about 10-25% of a glycerol ester of C14, C18 fatty acids; about 1-5% of a mink oil; about 10-20% of a glycerol monooleate; about 1-8% of a tallow; about 25-35% of a Stoddard solvent; about 4-12% of a mineral spirits, a naptha, or a combination; about 10-20% of a mineral oil; and about 1-5% of a monoterpene.

In an alternative embodiment the specific percentages of the components comprise, consist of, or consist essentially of: carnauba wax blend about 11%; 1,2,4 trimethylbenzene about 2%; glycerol ester of C14, C18 fatty acids about 14%; mink oil (mixed C12 to C-20) about 2%; glycerol monooleate about 14%; bleached tallow about 3%; Stoddard Solvent about 30%; mineral spirits or naptha about 7%; heavy mineral oil about 16%; and D-limonene about 2%. The composition may include less than 1% fragrance such as, but not limited to citrus, lemon, or orange fragrance.

In a still further embodiment for a cleaning and inhibiting composition, the composition of components are as follows: carnauba wax blend about 11.01%; 1,2,4 trimethylbenzene about 2.44%; glycerol ester of C14, C18 fatty acids about 13.88%; mink oil (mixed C12 to C-20) about 1.88%; glycerol monooleate about 13.70%; bleached tallow about 2.84%; Stoddard Solvent about 29.22%; mineral spirits or naptha about 6.60%; heavy mineral oil about 15.93%; and D-limonene about 2.00%. The composition may include about 0.25% citrus fragrance and about 0.25% orange fragrance.

Generally, the prevention and inhibition composition disclosed herein may take any form known to those of ordinary skill in the art now or in the future for protective barriers and prevention coatings or inhibitors including, but not limited to: a cream, a paste, a solution, a liquid, a lotion, an ointment and/or a gel.

In certain embodiments, the prevention and inhibition composition will be applied as follows. First, the surface of the object to be treated will be heated to a temperature warm enough to melt or liquefy the rust prevention and inhibition composition on contact. In one embodiment, this will be about 100° F.-140° F., preferably about 120° F. Then, the prevention and inhibition composition will be added to the surface of the object to be treated, keeping the surface warm during the application. In one embodiment, this application will occur with a soft-bristle brush. Once the application is complete, the treated object will be allowed to cool back to normal room temperature. In other modes of application, the surface of the object to be treated will not be heated; the composition will simply be applied by another methodology known to those of ordinary skill in the art that does not require a preheating of the material surface (e.g., spreading, brushing, spraying, etc. to a room temperature surface).

In other embodiments, in particular for the embodiment of the prevention and inhibition composition for the homo-goods industry, the composition is applied to the desired surface with a soft cloth, paper towel, sponge, brush or other application mechanism known to those of ordinary skill in the art. After application, the desired surface will be wiped or buffed clean. This application process can be repeated as needed. Desired surfaces for application include, but are not limited to, stainless steel, glass, leather, vinyl, cardboard, copper, sterling silver, fiberglass, aluminum and brass.

In one embodiment, the disclosed rust prevention composition is created by the following process. In a first step, the carnauba wax blend, 1,2,4 trimethylbenzene, glycerol ester of C14-C18 fatty acid, mink oil, glycerol monooleate, bleached tallow, Stoddard solvent, mineral spirits/naptha and carbon black dye are all healed by a method known to those of ordinary skill in the art until they liquefy. In one embodiment of this first step, the carnauba wax will be liquefied by placing a quantity of the carnauba wax (such as 5 gallons) into a heating mechanism (such as a heat box) which is heated to a temperature of about 175° F. for about 5-6 hours. In another embodiment of this first step, the 1,2,4 trimethylbenzene, glycerol ester of C14-C18 fatty acid, mink oil, glycerol monooleate, bleached tallow, Stoddard solvent, mineral spirits/naptha and carbon black dye will all be placed into a heating mechanism known to those of ordinary skill in the art (such as an oven) which is heated to about 140° F.-145° F.

In a second step, a container is heated to about 140° F.-200° F., in a preferred embodiment to about 175° F. Generally, any container or heating mechanism known to those of ordinary skill in the art is contemplated. In one embodiment, an aluminum or stainless steel container is utilized. In another embodiment, the container is heated to the applicable temperature by placing the container over heated coils. In a third step, the carnauba wax is added to the pre-heated container. In this step, the carnauba wax is maintained at a temperature within the range of about 140° F.-200° F., preferably about 175° F. for a period of about 30 minutes. In one embodiment of this step, the carnauba wax will be stirred by a stirring mechanism known to those of ordinary skill in the art at regular time intervals, in one embodiment at three (3) minute time intervals.

In a fourth step, the glycerol monooleate, Stoddard solvent, mineral spirits and naptha will be added to the carnauba wax and the temperature of the mixture will be maintained at within the range of about 140° F.-200° F., preferably about 175° F. for a period of about 3-5 minutes. In one embodiment of this step, the mixture will be stirred by a stirring mechanism known to those of ordinary skill in the art for a certain time period, in one embodiment for about 30 seconds. In a fifth step, the carbon black dye is added to the mixture. In one embodiment of this step, the mixture will be stirred by a stirring mechanism known to those of ordinary skill in the art for a certain time period, in one embodiment for about 1-2 minutes.

In a sixth step, the mixture will be maintained at a temperature within the range of about 140° F.-200° F. preferably about 175° F. for a certain time period. In a preferred embodiment, the mixture will be maintained at a temperature within the range of about 140° F.-200° F., preferably about 175° F. for about five (5) minutes. At the end of this allocated time period, in a seventh step, the mixture will be stirred by a stirring mechanism known to those of ordinary skill in the art.

In an eighth step, the resultant mixture will be dispensed and allowed to cool and cure to room temperature by methods known to those of ordinary skill in the art. In one embodiment of the disclosed process, about 640 ounces of the carnauba wax; about 31.60 ounces of animal oil; about 31.60 ounces of trimethylbenzene. Stoddard solvent and naptha (equal parts combined and about 2.25 ounces of carbon black 70 dye) will be utilized.

In the alternative embodiment of the prevention composition for the home-goods industry, another contemplated method for creating the composition is as follows. First, the carnauba wax, trimethylbenzene and Stoddard solvent are combined and heated to about 175° F. In a second step, the glycerol esters, animal oil, glycerol monooleate and bleached tallow are heated separately from the first combination to about 140° F. In a third step, the second combination is added to the first combination. In a fourth step, the mineral spirits are heated to about 140° F. and added to the mix. In a fifth step, the mineral oil is added and mixed. In a sixth step, the fragrance is added. In a seventh step, the mixture is heated to about 170° F. and stirred for about 5 minutes. In a final step, the resultant mixture is dispensed and allowed to cool and cure to room temperature by methods known to those of ordinary skill in the art.

Regardless of the method used above, the cleaning agent may be added to the composition when forming the rust inhibiting composition to form the cleaning and inhibiting composition, or the rust inhibiting composition nay be completely formed as contemplated above and the cleaning composition then added to that composition.

The advantages of the disclosed prevention composition are its ability to act as a protective barrier against moisture and ultraviolet rays for the material upon which it is applied, thereby inhibiting and preventing the deterioration and degradation caused by these elements over time, even in extreme conditions. When the cleaning agent has been added, the combined cleaning and rust inhibiting composition can serve to both clean and protect a metal or other surface in a single application step using any of the application methods contemplated herein.

Preliminary testing has shown that the disclosed compositions have the ability to prevent the formation of rust in numerous extreme conditions including thermal shock conditions, 1000 hour salt fog (60% solution) conditions, acid exposure conditions, abrasive testing conditions, and salt spray (92% solution) conditions. In each of the preliminary testing environments, the disclosed composition was applied to a steel tie rod end followed by an adequate cure time known to those of ordinary skill in the art. Following the cure period, the treated rod was exposed to each of five preliminary testing environments as follows:

Thermal Shock Test

In the thermal shock test, a treated rod was exposed to extreme temperatures within the range of about −140° F. to 135° F. for about 10 hours. Specifically, in this test the component was heated to 135° F. and then the temperature was cycled to about −140° F. at various intervals, ranging from about 5 minutes to about 1 hour. This cyclic temperature change was repeated for about 10 hours. The completion of the 10 hour thermal shock test revealed no measurable degree of deterioration, corrosion or discoloration of the treated rod. In this test, the composition provided 100% durability.

1000 Hour Salt Fog (60% Solution) Test

In the salt fog test, a treated rod was exposed to about a 60% salt solution for about 1000 hours. Specifically, in this test the component was placed in a salt fog chamber for about 1000 hours and exposed to a 60% salt solution. After the completion of the test, the treated rod was removed and inspected visually and with a magnifying scope. The inspection revealed no measurable degree of deterioration, discoloring, corrosion, or degradation to the coating or the treated rod. Thus, live prevention composition provided remarkable protection and corrosion resistance, providing 100% corrosion protection and durability.

Acid Exposure Test

In the acid exposure test, a treated rod was exposed to a hydrochloric acid solution for about ½ hour. Specifically, in this test the treated rod was placed in a sealed chamber and exposed to a diluted solution of 38% hydrochloric acid. As known to those of ordinary skill in the art, a diluted solution of hydrochloric acid will quickly rust mild steel components. The treated rod was then exposed to an intermittent spray of the diluted acid solution for about ½ hour. Upon completion of the test, the treated rod was removed for inspection. The inspection revealed no measurable degree of deterioration, discoloring or corrosion; the prevention composition had provided 100% protection and durability. Further, the inspection revealed that the acid solution remained on the surface of the treated rod without any measurable penetration of the coating of the disclosed prevention composition.

Abrasive (Impact) Test

In the abrasive (impact) test, a treated rod was exposed to simulated abrasive materials for about an hour. In this test, the treated rod was placed in a sealed chamber and exposed to a variety of different materials including but not limited to ground glass, sand and rock for about an hour. The abrasive materials were generally applied to the treated rod at about 30 psi from a distance of about 17 mm. After-testing inspection revealed that the treated rod was not damaged during the testing, no visible signs of damage or pitting were evident in the coating of the prevention material or on the rod. In sum, the treated rod showed 100% durability in this test.

Salt Spray Test (92% Solution)

In the salt spray test, a treated rod was exposed to a salt spray solution which contained about 92% brine solution for about 60 hours at about 15 psi spray pressure and about 60 percent humidity. Notably, this is an extremely high solution of salt saturation. Specifically, in the lest the treated rod was placed in a salt spray container containing about a 92% Brine solution. The treated rod was exposed to the 92% solution for about 60 hours with a 15 psi spray pressure during the test. An inspection following the test revealed no measurable degree of deterioration, discoloring or corrosion. The 92% salt spray (a highly concentrated solution with properties that will quickly corrode metal) test revealed that the prevention composition provided excellent protection from the corrosive effects of the testing solution; 100% protection and durability was demonstrated upon inspection.

In sum, these preliminary test results reveal the remarkable protection and durability from moisture provided to iron and iron alloys by the prevention composition disclosed herein. This same protection from the damage caused by moisture and sunlight is also believed provided to other materials upon which the composition is applied including but not limited to metals (e.g., stainless steel, iron, aluminum, precious metals, etc.), plastics, vinyl, wood, rubber and any other materials that are at risk for deterioration and degradation from exposure to moisture and ultraviolet rays over time. Further, the disclosed composition can also be utilized for other useful functions to prevent certain moistures, oils or other substances from coming into contact with treated materials. The prevention of fingerprints and smudges on stainless steel coated with the disclosed composition is one such example. The prevention of deterioration from acid rain on treated metals and other materials is another example.

While the invention has been disclosed in conjunction with a description of certain embodiments, including those that are currently relieved to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “parallel” are purely geometric constructs and no real-world component or relationship is truly “parallel” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A rust inhibition and cleaning composition comprising:
10-20% of a carnauba wax;
1-8% of a 1,2,4 trimethylbenzene;
10-25% of a glycerol ester of C14, C18 fatty acids;
1-5% of a mink oil;
10-20% of a glycerol monooleate;
1-8% of a tallow;
25-35% of a Stoddard solvent;
4-12% of a mineral spirits, a naptha, or a combination;
10-20% of a mineral oil; and
1-5% of a cleaning agent including: a monoterpene, a monoterpenoid, or a combination thereof.

2. The composition of claim 1 further comprising a fragrance.

3. The composition of claim 2 wherein said fragrance comprises 0.1-1% of said composition.

4. The composition of claim 2 wherein said fragrance includes citrus fragrance.

5. The composition of claim 4 wherein said fragrance includes orange fragrance.

6. The composition of claim 1 wherein said cleaning agent includes a monocyclic monoterpene.

7. The composition of claim 1 wherein said cleaning agent includes a monocyclic monoterpenoid.

8. The composition of claim 1 wherein said cleaning agent includes D-limonene.

9. The composition of claim 1 comprising:
about 11% carnauba wax;
about 2% 1,2,4 trimethylbenzene;
about 14% glycerol ester of C14, C18 fatty acids;
about 2% mink oil;
about 14% glycerol monooleate;
about 3% tallow;
about 30% Stoddard solvent;
about 7% mineral spirits;
about 16% a mineral oil; and
about 2% D-limonene.

10. The composition of claim 1 comprising:
about 11.01% carnauba wax;
about 2.44% 1,2,4 trimethylbenzene;
about 13.88% glycerol ester of C14, C18 fatty acids;
about 1.88% mink oil;
about 13.70% glycerol monooleate;
about 2.84% tallow;
about 29.22% Stoddard solvent;
about 6.60% mineral spirits;
about 15.93% a mineral oil; and
about 2.00% D-limonene.

11. A method for applying a cleaning and rust inhibition composition to a surface of an inorganic object to be treated, the method comprising:
providing a rust inhibition composition;
heating the surface of the inorganic object to be treated to a temperature warm enough to melt or liquefy the rust inhibition composition on contact;
applying the rust inhibition composition to the healed surface of the inorganic object to be treated, keeping the surface warm during the applying; and
cooling the surface of the inorganic object to be treated back to room temperature after the step of applying;
wherein the rust inhibition prevention composition comprises of a mixture of:
10-20% of a carnauba wax;
1-8% of a 1,2,4 trimethylbenzene;
10-25% of a glycerol ester of C14, C18 fatty acids;
1-5% of a mink oil;
10-20% of a glycerol monooleate;
1-8% of a tallow;
25-35% of a Stoddard solvent;
4-12% of a mineral spirits, a naptha, or a combination;
10-20% of a mineral oil; and
1-5% of a cleaning agent including: a monoterpene, a monoterpenoid, or a combination thereof.

12. The method of claim 11 further comprising a fragrance.

13. The method of claim 12 wherein said fragrance comprises 0.1-1% of said composition.

14. The method of claim 12 wherein said fragrance includes citrus fragrance.

15. The method of claim 14 wherein said fragrance includes orange fragrance.

16. The method of claim 11 wherein said cloning agent includes a monocyclic monoterpene.

17. The method of claim 11 wherein said cleaning agent includes a monocyclic monoterpenoid.

18. The method of claim 11 wherein said cleaning agent includes D-limonene.

19. The method of claim 11 comprising:
about 11% carnauba wax;
about 2% 1,2,4 trimethylbenzene;
about 14% glycerol ester of C14, C18 fatty acids;
about 2% mink oil;
about 14% glycerol monooleate;
about 3% tallow;
about 30% Stoddard solvent;
about 7% mineral spirits;
about 16% a mineral oil; and
about 2% D-limonene.

20. The method of claim 11 comprising:
about 11.01% carnauba wax;
about 2.44% 1,2,4 trimethylbenzene;
about 13.88% glycerol ester of C14, C18 fatty acids;
about 1.88% mink oil;
about 13.70% glycerol monooleate;
about 2.84% tallow;
about 29.22% Stoddard solvent;
about 6.60% mineral spirits;
about 15.93% a mineral oil; and
about 2.00% D-limonene.
